(19) United States
(12) Patent Application Publication
(10) Pub. No.: US 2011/0305406 A1
(43) Pub. Date: Dec. 15, 2011

(54) BUSINESS CARD RECOGNITION SYSTEM

(75) Inventor: Ying-Jieh Huang, Taipei (TW)

(73) Assignee: PRIMAX ELECTRONICS LTD., Taipei (TW)

(21) Appl. No.: 12/836,859

(22) Filed: Jul. 15, 2010

(30) Foreign Application Priority Data
Jun. 11, 2010 (TW) 099119065

(51) Int. Cl. G06K 7/10

(52) U.S. Cl. 382/321

(57) ABSTRACT

A business card recognition system includes a mobile communication apparatus and a computer host. The mobile communication apparatus has an image pickup device. The computer host is in communication with the mobile communication apparatus. When the image pickup device of the mobile communication apparatus is used to shoot a business card, a business card image is acquired. After the business card image is transmitted to the computer host, the computer host performs an optical character recognition operation on the business card image, thereby obtaining business card information. By searching address information of the business card information, the computer host acquires an address proximity map image. The business card information and the address proximity map image are transmitted from the computer to the mobile communication apparatus. As such, the user of the mobile communication apparatus can realize the business card information and the address proximity map image.

### FIELD OF THE INVENTION

The present invention relates to a business card recognition system for reading information of a business card.

### BACKGROUND OF THE INVENTION

With increasing development of science and technology, the social relations are gradually developed from agricultural and industrial type relations to commercial type relations. The commercial actions such as human communications or client visits become very frequent in modern societies. Generally, during self-introductions in the commercial occasions, business cards are usually given to the customers or business staffs. As known, business cards are cards bearing business information about a company or individual. The business information includes for example a telephone number, an addresser, an e-mail address, or the like. The regular workers of certain-scale companies may usually get their own business cards from the companies. In other words, business cards are very important to promote business.

Conventionally, when a business card is received, the business card is collected in a business card book or the information associated with the business card is written into an address book. With increasing development of digital techniques, the information of the business card is gradually created as an electronic file. Generally, the business card is scanned by scanning apparatuses and then saved as a business card electronic file such as a PDF (Portable Document Format) file. As such, the information of the business card could be further processed or managed, and the drawback of losing the business card or the address book with the business card information will be minimized. However, the scanning apparatus is not always an essential computer peripheral device for most users. In a case that no scanning apparatus is available, the image of the business card may be shot by an image pickup device externally connected with a computer or a built-in image pickup device of a notebook computer. The shot image is saved as a business card electronic file. The business card electronic file is for example an image file such as a JPEG (Joint Photographic Experts Group) file. Whereas, most users prefer using scanning apparatuses to scan the business card as the PDF file because the characters and signs contained in the PDF file are readable by the computer system and may be converted into a text file to be edited or stored.

As known, optical character recognition (OCR) is a process of shooting an image of a document and then extracting the characters from the image. After the image acquired by the image pickup device is saved as a JPEG file, the JPEG file can be analyzed according to the OCR technique. In addition, individual characters or signs contained in the JPEG file can be recognized and converted into an editable text file. Since the associated OCR techniques are well established, the image pickup device is gradually adopted to obtain electronic files of business cards.

However, when an image pickup device externally connected with a computer or a built-in image pickup device of a notebook computer is used to shoot a business card, some difficulties possibly occur. For example, the image pickup device of a typical notebook computer has a prime lens with a preset focal length of approximately 60 centimeters. For using the image pickup device to shoot a full-page business card that is completely within the shooting range of the image pickup device, all pixels of the image pickup device need to be utilized to obtain the largest image. Under this circumstance, the distance between the image pickup device and the business card is deviated from the preset focal length (i.e. 60 centimeters), and thus the obtained image of the business card is usually blurred and fails to be recognized by the naked eyes. After the characters or signs contained in the blurred image are subject to an OCR technique, the recognition rate of the characters is usually insufficient.

For using the prime lens of the image pickup device to obtain a sharp image of the business card, an external lens is usually arranged in front of the image pickup device. The use of the external lens could change the preset focal length of the image pickup device in order to shoot the full page of a nearby or faraway document. Generally, the external lens is a zoom lens with an adjustable focal length or a prime lens with different fixed focal lengths. Alternatively, the image pickup device having a zoom function may be used to shoot a nearby business card. However, the use of either the external lens or the image pickup device having a zoom function increases additional cost.

### SUMMARY OF THE INVENTION

It is an object of the present invention to provide a business card recognition system with reduced cost.

In accordance with an aspect of the present invention, there is provided a business card recognition system. The business card recognition system includes a mobile communication apparatus and a computer host. The mobile communication apparatus has an image pickup device, which is used for shooting a business card, thereby acquiring a business card image. The business card image includes a name information image, a telephone information image and an address information image. The computer host is in communication with the mobile communication apparatus for receiving the business card image from the mobile communication apparatus. The computer host includes an optical character recognition program and an automatic operating program. The optical character recognition program is used for recognizing the business card image, and converting the name information image, the telephone information image and the address information image into a name information, a telephone information and an address information, respectively. The automatic operating program is used for searching the address information to acquire an address proximity map image, and transmitting the name information, the telephone information, the address information and the address proximity map image to the mobile communication apparatus.

In an embodiment, the computer host further includes an address database. The address proximity map image is acquired from the address database when the address information is searched.

In an embodiment, the computer host is in communication with an internet, and the automatic operating program is connected to an address search web page through the internet, so that the address information is searched through the address search web page to acquire the address proximity map image.

In an embodiment, the computer host is in communication with the mobile communication apparatus according to a Bluetooth transmission technology, an infrared transmission technology or a USB transmission technology or via a communication network to transmit the name information, the telephone information, the address information and the address proximity map image. The communication network includes an internet and a mobile network. The internet and the mobile network are in communication with each other. The computer host is in communication with the internet. The mobile communication apparatus is in communication with the mobile network.

In an embodiment, the mobile network is a 3G network, a Wifi network, a GPRS network or an Edge network.

In an embodiment, the mobile communication apparatus further includes a screen, a storage device and a prompt program. The screen is used for displaying the business card image, the name information, the telephone information, the address information or the address proximity map image. The storage device is used for storing the business card image and the name information, the telephone information, the address information and the address proximity map image that are transmitted to the mobile communication apparatus. The prompt program is used for generating a prompt message when the name information, the telephone information, the address information and the address proximity map image from the computer host are received by the mobile communication apparatus.

In an embodiment, the business card image further includes an e-mail information image, which is converted into an e-mail information by the optical character recognition program. The e-mail information is transmitted to the mobile communication apparatus, so that the mobile communication apparatus issues an e-mail according to the e-mail information.

In an embodiment, the computer host further includes an image processing program and a country code program. The image processing program is executed for performing a trimming operation or a light-compensating operation on the business card image. The country code program is executed for providing a country code. When the telephone information image is converted into the telephone information, the country code program is executed to add a country code to the telephone information, thereby generating corresponding international telephone information. The international telephone information is transmitted to the mobile communication apparatus, so that the mobile communication apparatus dials according to the international telephone information.

In an embodiment, when the business card image from the mobile communication apparatus is received by the computer host, the optical character recognition program is activated by the automatic operating program so as to recognize the business card image and acquire the name information, the telephone information and the address information from the business card image. The automatic operating program acquires the address proximity map image by searching the address information, and transmits the name information, the telephone information, the address information and the address proximity map image to the mobile communication apparatus.

In an embodiment, after the name information, the telephone information and the address information are received by the mobile communication apparatus, the mobile communication apparatus is connected with a path planning web page through a mobile network. By inputting current position address information of the mobile communication apparatus into the path planning web page, a path planning route information between the current position address information and the address information is acquired.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic block diagram illustrating a business card recognition system according to a first embodiment of the present invention;

FIG. 2 is a schematic diagram illustrating the business card image acquired by the business card recognition system according to the first embodiment of the present invention; and

FIG. 3 is a schematic block diagram illustrating a business card recognition system according to a second embodiment of the present invention.

### DETAILED DESCRIPTION OF THE PREFERRED EMBODIMENT

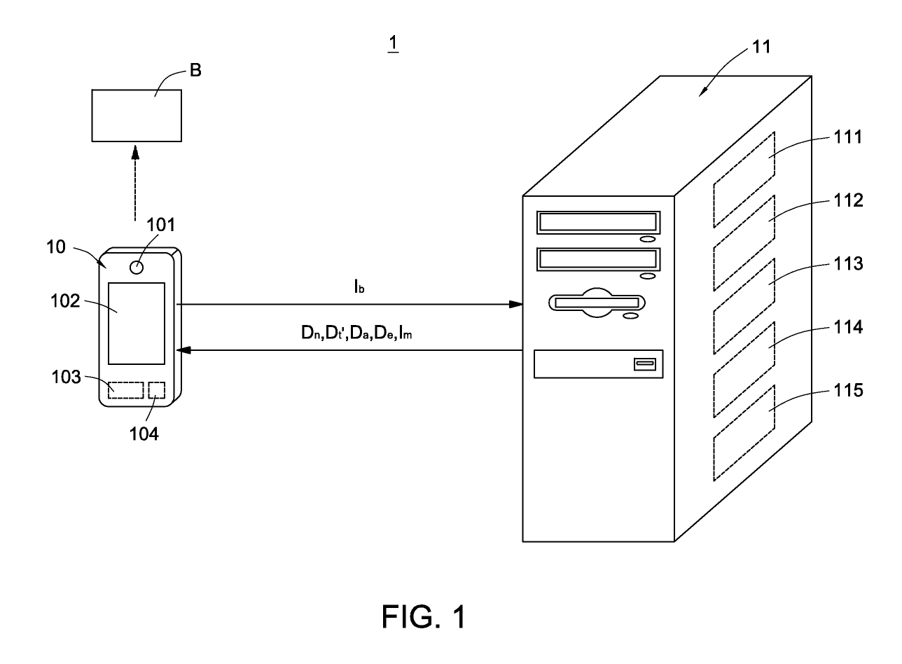

For obviating the drawbacks encountered from the prior art, the present invention provides a business card recognition system. FIG. 1 is a schematic block diagram illustrating a business card recognition system according to a first embodiment of the present invention. As shown in FIG. 1, the business card recognition system 1 comprises a mobile communication apparatus 10 and a computer host 11. The mobile communication apparatus 10 comprises an image pickup device 101, a screen 102, a storage device 103 and a prompt program 104. The image pickup device 101 of the mobile communication apparatus 10 is used for shooting a business card B, thereby acquiring a business card image I_{b}. In this embodiment, the mobile communication apparatus 10 is a mobile phone. The screen 102 is used for displaying the business card image I_{b}. The storage device 103 is used for storing the business card image I_{b}. An example of the storage device 103 includes a built-in memory space of the mobile phone or a memory card. Once any information from the computer host 11 is received by the mobile communication apparatus 10, the prompt program 104 issues a prompt message.

The computer host 11 is in communication with the mobile communication apparatus 10 for receiving the business card image I_{b} from the mobile communication apparatus 10. The computer host 11 comprises an optical character recognition (OCR) program 111, an automatic operating program 112, an image processing program 113, a country code program 114 and an address database 115. The optical character recognition program 111 is used for performing an optical character recognition operation on the business card image I_{b} to extract characters from the business card image I_{b}, thereby shooting the information of the business card image I_{b}. The image processing program 113 is used for performing an image processing operation (e.g. a trimming operation or a light-compensating operation) on the business card image I_{b}. The country code program 114 is used for providing a country code. A large number of maps have been stored in the address database 115. In this embodiment, the computer host 11 is in communication with the mobile communication apparatus 10 according to a Bluetooth transmission technology, an infrared transmission technology or a USB (Universal Series Bus) transmission technology. The business card image I_{b} is transmitted according to these transmission technologies.

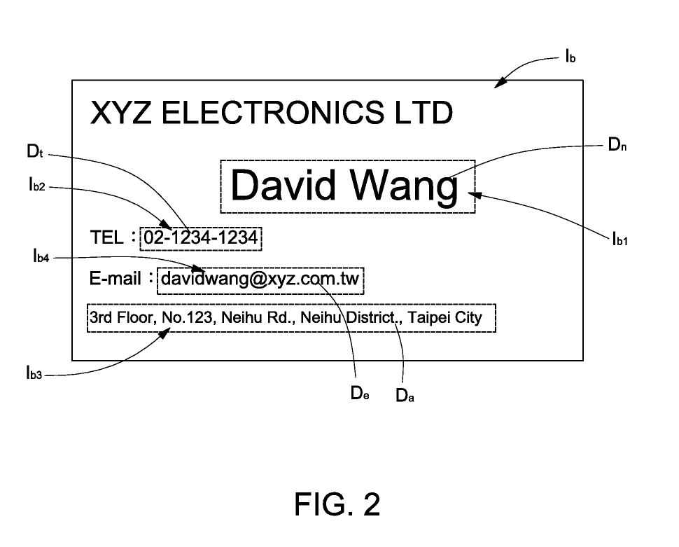

The contents of the business card image I_{b} that is acquired by using the image pickup device 101 of the mobile communication apparatus 10 to shoot the business card B are shown in FIG. 2. FIG. 2 is a schematic diagram illustrating the business card image acquired by the business card recognition system according to the first embodiment of the present invention. As shown in FIG. 2, the business card image I_{b} comprises a name information image I_{b1}, a telephone information image I_{b2}, an address information image I_{b3} and an e-mail information image I_{b4}. The business card image I_{b} is an image of a name information Dₙ. The telephone information image I_{b2} is an image of a telephone information D. The address information image I_{b3} is an image of an address information Dₐ. The e-mail information image I_{b4} is an image of an e-mail information Dₑ. In the business card image I_{b}, the name information Dₙ, the telephone information Dₜ, the address information Dₐ and the e-mail information Dₑ fail to be directed edited and retrieved.

Please refer to FIGS. 1 and 2 again. After the business card image I_{b} is acquired by using the image pickup device 101 of the mobile communication apparatus 10 to shoot the business card B, the business card image I_{b} may be transmitted from the mobile communication apparatus 10 to the computer host 11. In addition, after the prompt program 104 of the mobile communication apparatus 10 is activated, the prompt program 104 will judge whether any information from the computer host 11 is received. When the business card image I_{b} is received by the computer host 11, the image processing program 113 is activated by the automatic operating program 112. As such, the image processing program 113 is executed to analyze the business card image I_{b}. If the image processing program 113 judges that the background image surrounding the business card image I_{b} is too large, an trimming operation is performed on the business card image I_{b} by the image processing program 113, thereby removing the background image. Whereas, if the image processing program 113 judges that the brightness of the business card image I_{b} is too high or too low, an light-compensating operation is performed on the business card image I_{b} by the image processing program 113, thereby compensating the brightness of the business card image I_{b}. Of course, if the image processing program 113 judges that the business card image I_{b} is normal, no image processing operation is necessarily performed on the business card image I_{b}. In this embodiment, the image processing operation to be performed by the image processing program 113 is illustrated by referring to the trimming operation and the light-compensating operation. Nevertheless, those skilled in the art will readily observe that other image processing operations can also be performed by the image processing program 113, and are not redundantly described herein.

After the image processing program 113 judges that the image processing program on the business card image I_{b} has been done, the optical character recognition program 111 is activated by the automatic operating program 112. Then, by the optical character recognition program 111, an optical character recognition operation is performed on the business card image I_{b} that has been image-processed or is not required to be image-processed. After the optical character recognition operation is performed, the name information image I_{b1}, the telephone information image I_{b2}, the address information image T_{b3} and an e-mail information image I_{b4} of the business card image I_{b} are converted into the name information Dₙ, the telephone information Dₜ, the address information Dₐ and the e-mail information Dₑ, respectively. Meanwhile, the name information Dₙ, the telephone information Dₜ, the address information Dₐ and the e-mail information Dₑ are retrievable and editable text files. Then, the automatic operating program 112 accesses the address database 115 of the computer host 11. In addition, the address information Dₐ is inputted as a search keyword, and thus an address proximity map image Iₘ associated with the address information Dₐ is searched from the address database 115. Alternatively, the country code program 114 is activated by the automatic operating program 112. The country code program 114 is executed to add a country code to the telephone information Dₜ, thereby generating an international telephone information D_{t′}. In this embodiment, the country code preset by the country code program 114 is 886 (i.e. the country code of Taiwan).

Afterwards, by the automatic operating program 112, the name information Dₙ, the international telephone information D_{t′}, the address information Dₐ and the e-mail information Dₑ obtained from the optical character recognition operation and the address proximity map image Iₘ obtained from the address database 115 are transmitted to the mobile communication apparatus 10. When the name information Dₙ, the international telephone information D_{t′}, the address information Dₐ, the e-mail information Dₑ and the address proximity map image Iₘ are received by the mobile communication apparatus 10, the prompt program 104 will issue a prompt message and a prompt sound to notify the user that the information from the computer host 11 has been received. The information Dₙ, D_{t′}, Dₐ, Dₑ and the address proximity map image Iₘ are stored in the storage device 103. When the user wants the information Dₙ, D_{t′}, Dₐ, Dₑ and the address proximity map image Iₘ, the user may open the information Dₙ, D_{t′}, Dₐ, Dₑ and the address proximity map image Iₘ from the storage device 103. As such, the information Dₙ, D_{t′}, Dₐ, Dₑ and the address proximity map image Iₘ will be shown on the screen 102.

Take the business card image I_{b} of FIG. 2 for example. When the business card B is given to the user, the information Dₙ, D_{t′}, Dₐ, Dₑ and the address proximity map image Iₘ can be obtained by the above-mentioned method. As shown in FIG. 2, the name information Dₙ includes the content “David Wang”; the telephone information Dₜ includes the content “02-1234-1234”; the address information Dₐ includes the content “3rd Floor, No. 123, Neihu Rd., Neihu District., Taipei City”; and the e-mail information Dₑ includes the content davidwang@xyz.com.tw. In addition, the address proximity map image Iₘ is the proximity map of the address “3rd Floor, No. 123, Neihu Rd., Neihu District., Taipei City”. When the user wants to dial the telephone of David Wang through the mobile communication apparatus 10, the user may retrieve the name information Dₙ (i.e. David Wang) from the storage device 103 so as to obtain a corresponding international telephone information D_{t′} (i.e. +886212341234). When the user wants to go to the position corresponding to the address information Dₐ (i.e. 3rd Floor, No. 123, Neihu Rd., Neihu District., Taipei City), the user may open the address proximity map image Iₘ such that the address proximity map image Iₘ is shown on the screen 102. Through the screen 102, the user may browse the proximity map at the position corresponding to the address information Dₐ so as to facilitate the user to realize the environment proximity to the position corresponding to the address information Dₐ.

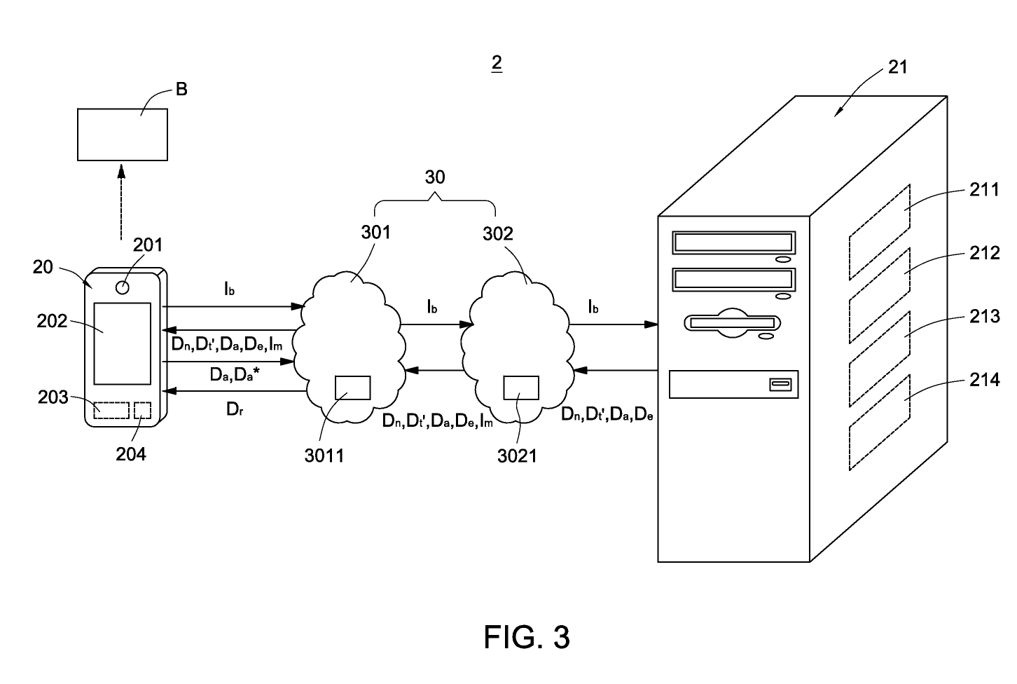

The present invention further provides a second embodiment. FIG. 3 is a schematic block diagram illustrating a business card recognition system according to a second embodiment of the present invention. As shown in FIG. 3, the business card recognition system 2 comprises a mobile communication apparatus 20 and a computer host 21. The mobile communication apparatus 20 comprises an image pickup device 201, a screen 202, a storage device 203 and a prompt program 204. The image pickup device 201 of the mobile communication apparatus 20 is used for shooting a business card B, thereby acquiring a business card image I_{b}. The business card image I_{b} is the same as that of FIG. 2. In this embodiment, the mobile communication apparatus 20 is also a mobile phone. The functions of the screen 202, the storage device 203 and the prompt program 204 are identical to those illustrated in the first embodiment, and are not redundantly described herein.

The computer host 21 is in communication with the mobile communication apparatus 20 for receiving the business card image I_{b} from the mobile communication apparatus 20. The computer host 21 comprises an optical character recognition (OCR) program 211, an automatic operating program 212, an image processing program 213 and a country code program 214. The optical character recognition program 211 is used for performing an optical character recognition operation on the business card image I_{b} to extract characters from the business card image I_{b}, thereby shooting the information of the business card image I_{b}. The image processing program 213 is used for performing an image processing operation (e.g. a trimming operation or a light-compensating operation) on the business card image I_{b}. The country code program 214 is used for providing a country code. In this embodiment, the computer host 21 is in communication with the mobile communication apparatus 20 via a communication network 30. That is, the business card image I_{b} is transmitted via the communication network 30. The communication network 30 includes a mobile network 301 and an internet 302. The mobile network 301 and the internet 302 are in communication with each other. The computer host 21 is in communication with the internet 302. The mobile communication apparatus 20 is in communication with the mobile network 301. An example of the mobile network 301 includes but is not limited to a 3G network, a Wifi network, a GPRS network or an Edge network.

Please refer to FIGS. 2 and 3 again. After the business card image I_{b} is acquired by using the image pickup device 201 of the mobile communication apparatus 20 to shoot the business card B, the business card image I_{b} may be transmitted from the mobile communication apparatus 20 to the computer host 21 through the internet 302 and the mobile network 301. In addition, after the prompt program 204 of the mobile communication apparatus 20 is activated, the prompt program 204 will judge whether any information from the computer host 21 is received. When the business card image I_{b} is received by the computer host 21, the image processing program 213 is activated by the automatic operating program 212. As such, the image processing program 213 is executed to analyze the business card image I_{b}. Moreover, the image processing program 213 may judge whether any image processing operation is necessarily performed on the business card image I_{b}. The image processing operation is identical to that illustrated in the first embodiment, and is not redundantly described herein.

Next, the optical character recognition program 211 is activated by the automatic operating program 212. By the optical character recognition program 211, an optical character recognition operation is performed on the business card image I_{b} that has been image-processed or is not required to be image-processed. After the optical character recognition operation is performed, the name information image I_{b1}, the telephone information image I_{b2}, the address information image I_{b3} and an e-mail information image I_{b4} of the business card image I_{b} are converted into a name information Dₙ, a telephone information Dₜ, an address information Dₐ and an e-mail information Dₑ, respectively. Meanwhile, the name information Dₐ, the telephone information Dₜ, the address information Dₐ and the e-mail information Dₑ are retrievable and editable text files.

Then, the automatic operating program 212 is connected to an address search web page 3021 through the internet 302. In addition, the address information Dₐ is inputted as a search keyword, and thus an address proximity map image Iₘ associated with the address information Dₐ is searched through the address search web page 3021. In an embodiment, the address search web page 3021 is a Google Map web page. In addition, the country code program 214 is activated by the automatic operating program 212. The country code program 214 is executed to add a country code to the telephone information Dₜ, thereby generating an international telephone information D_{t′}. Then, by the automatic operating program 212, the name information Dₙ, the international telephone information D_{t′}, the address information Dₐ, the e-mail information Dₑ and the address proximity map image Iₘ are transmitted to the mobile communication apparatus 20. When the name information Dₙ, the international telephone information D_{t′}, the address information Dₐ, the e-mail information Dₑ and the address proximity map image Iₘ are received by the mobile communication apparatus 20, the prompt program 204 will notify the user that the information from the computer host 21 has been received. The information Dₙ, D_{t′}, Dₐ, Dₑ and the address proximity map image Iₘ are stored in the storage device 203. When the user wants the information Dₙ, D_{t′}, Dₐ, Dₑ and the address proximity map image Iₘ, the user may open the information Dₙ, D_{t′}, Dₐ, Dₑ and the address proximity map image Iₘ from the storage device 203. As such, the information Dₙ, D_{t′}, Dₐ, Dₑ and the address proximity map image Iₘ will be shown on the screen 202.

The applications of the business card recognition system 2 may be distinguished from those of the first embodiment. The applications of the business card recognition system 2 will be illustrated by referring the business card image I_{b} as shown in FIG. 2. In a case that the user gets lost in the way toward the destination corresponding to the address information Dₐ and the user has not yet reached the landmark shown on the address proximity map image Iₘ, the mobile communication apparatus 20 may be connected with a path planning web page 3011 through the mobile network 301. By inputting current position address information D_{a*} of the mobile communication apparatus 20 and the address information Dₐ into the path planning web page 3011, the path planning route information Dᵣ associated with the route between the positions corresponding to the current position address information D_{a*} and the address information Dₐ will be acquired. According to the path planning route information Dᵣ, the user can realize a proper route to go to the position corresponding to the current position address information D_{a*}.

It is noted that, according to the business card recognition system of the present invention, it the not necessary to use the country code program to add the country code to the telephone information. Optionally, the country code program may be closed through the settings by the user. In this situation, the telephone information Dₜ obtained from the optical character recognition will be directly transmitted to the mobile communication apparatus.

From the above two embodiments, it is found that the business card recognition system of the present invention has many advantages. In the business card recognition system of the present invention, an image pickup device of a mobile communication apparatus is used to shoot a business card to acquire a business card image, the business card image is then transmitted to a computer host and an optical character recognition operation is performed on the business card image to obtain various editable and retrievable business card information, and finally the business card information will be transmitted to the mobile communication apparatus for facilitating the user to perform desired operations. Since the shooting function of the mobile communication apparatus is gradually improved, the use of the mobile communication apparatus to shoot the business card according to the business card recognition system of the present invention is more feasible. For example, since most of the commercially available mobile communication apparatuses have high-pixel image pickup devices, the shooting functions of these mobile communication apparatuses are better than those of the built-in image pickup devices of notebook computers. By means of the business card recognition system of the present invention, almost all of the user can use their mobile communication apparatuses to shoot business cards. Since no additional image pickup devices (and associated accessories) are needs to be purchased, the business card recognition system of the present invention is very cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A business card recognition system, comprising:
a mobile communication apparatus having an image pickup device, which is used for shooting a business card, thereby acquiring a business card image, wherein said business card image comprises a name information image, a telephone information image and an address information image; and
a computer host in communication with said mobile communication apparatus for receiving said business card image from said mobile communication apparatus, wherein said computer host comprises:
an optical character recognition program for recognizing said business card image, and converting said name information image, said telephone information image and said address information image into a name information, a telephone information and an address information, respectively; and
an automatic operating program for searching said address information to acquire an address proximity map image, and transmitting said name information, said telephone information, said address information and said address proximity map image to said mobile communication apparatus.

2. The business card recognition system according to claim 1 wherein said computer host further comprises an address database, wherein said address proximity map image is acquired from said address database when said address information is searched.

3. The business card recognition system according to claim 1 wherein said computer host is in communication with an internet, and said automatic operating program is connected to an address search web page through said internet, so that said address information is searched through the address search web page to acquire said address proximity map image.

4. The business card recognition system according to claim 1 wherein said computer host is in communication with said mobile communication apparatus according to a Bluetooth transmission technology, an infrared transmission technology or a USB transmission technology or via a communication network to transmit said name information, said telephone information, said address information and said address proximity map image, wherein said communication network includes an internet and a mobile network, said internet and said mobile network are in communication with each other, said computer host is in communication with said internet, and said mobile communication apparatus is in communication with said mobile network.

5. The business card recognition system according to claim 4 wherein said mobile network is a 3G network, a Wifi network, a GPRS network or an Edge network.

6. The business card recognition system according to claim 1 wherein said mobile communication apparatus further comprises:
a screen for displaying said business card image, said name information, said telephone information, said address information or said address proximity map image;
a storage device for storing said business card image and said name information, said telephone information, said address information and said address proximity map image that are transmitted to said mobile communication apparatus; and
a prompt program for generating a prompt message when said name information, said telephone information, said address information and said address proximity map image from said computer host are received by said mobile communication apparatus.

7. The business card recognition system according to claim 1 wherein said business card image further comprises an e-mail information image, which is converted into an e-mail information by said optical character recognition program, wherein said e-mail information is transmitted to said mobile communication apparatus, so that said mobile communication apparatus issues an e-mail according to said e-mail information.

8. The business card recognition system according to claim 1 wherein said computer host further comprises:
an image processing program for performing a trimming operation or a light-compensating operation on said business card image; and
a country code program for providing a country code, wherein when said telephone information image is converted into said telephone information, said country code program is executed to add a country code to said telephone information, thereby generating corresponding international telephone information, wherein said international telephone information is transmitted to said mobile communication apparatus, so that said mobile communication apparatus dials according to said international telephone information.

9. The business card recognition system according to claim 1 wherein when said business card image from said mobile communication apparatus is received by said computer host, said optical character recognition program is activated by said automatic operating program so as to recognize said business card image and acquire said name information, said telephone information and said address information from said business card image, wherein said automatic operating program acquires said address proximity map image by searching said address information, and transmits said name information, said telephone information, said address information and said address proximity map image to said mobile communication apparatus.

10. The business card recognition system according to claim 9 wherein after said name information, said telephone information and said address information are received by said mobile communication apparatus, said mobile communication apparatus is connected with a path planning web page through a mobile network, wherein by inputting current position address information of said mobile communication apparatus into said path planning web page, a path planning route information between said current position address information and said address information is acquired.
